(19) United States
(12) Patent Application Publication
(10) Pub. No.: US 2026/0196126 A1
(43) Pub. Date: Jul. 9, 2026

(54) Detecting a Mobile Device Pointing Toward Another Device

(71) Applicant: GOOGLE LLC, Mountain View, CA (US)

(72) Inventors: Patrick Muller AMIHOOD, Mountain View, CA (US); Cody Blair WORTHAM, Mountain View, CA (US)

(21) Appl. No.: 19/132,686

(22) PCT Filed: Apr. 26, 2023
(86) PCT No.: PCT/US2023/019901

§ 371 Date: May 23, 2025

(51) Int. Cl. G08C 17/02; G01S 3/48; G06F 3/01; G06F 3/0346

(52) U.S. Cl. CPC G08C 17/02; G01S 3/48; G06F 3/017; G06F 3/0346; G08C 2201/32

(57) ABSTRACT

In general, the subject matter described in this disclosure can be embodied in methods, systems, and program products for detecting a mobile device pointing gesture toward another device. A mobile device determines that the mobile device physically moved in a manner that satisfies criterion for a pointing gesture. The mobile device or another system device determines that the pointing is oriented toward a particular device, including by receiving a signal using a first antenna and a second antenna, and by determining an indication of a signal difference between receipt of the signal by the first antenna and the second antenna.

### TECHNICAL FIELD

This document generally relates to detecting a mobile device pointing toward another device.

### BACKGROUND

Some mobile computing devices include sensors that can determine orientation and/or movement of the computing devices. For example, a gyroscope mounted as part of a mobile computing device can be used to determine an orientation of the mobile computing device with respect to three axes, and determine how that mobile computing device rotates over time with respect to those axes. An accelerometer can additionally or alternatively be used to determine orientation and rotation, and can also be used to determine how a mobile computing device accelerates laterally. Some computing devices include multiple antennas, and can analyze differences in timing of signals received by the multiple antennas.

### SUMMARY

A computing system may be configured to determine that a user has performed a gesture to point a mobile device toward another device. As a result of determining that a mobile device was pointed toward another device, the computing system may initiate a cooperative activity between the mobile device and the other device. The other device may be a smartphone, a tablet, a television, a radio, a speaker, a tag device, or a dongle device attached to a communications port of a device. As an example, a user may point his phone toward a television, to cause a video that is being played by the phone to be cast to the television, such that the television begins playing the video and the user can control playback of video on the television using controls provided by a touchscreen of the phone.

Detecting that a mobile device has performed a pointing gesture toward another device may be dependent upon multiple criteria being satisfied. For example, a system may determine that the mobile device moved in a manner indicating that the mobile device has been pointed. Such a determination may analyze measurements by one or more orientation and/or movement sensors to determine that the mobile device has tilted toward a given direction and laterally moved in the same direction.

The system may also determine that the mobile device is oriented toward the other device. For example, the other device may emit a signal, during or after performance of the mobile device pointing gesture, and the mobile device may receive the emitted signal using multiple antennas of the mobile device. The mobile device may analyze a signal difference between receipt of the signal by the multiple antennas. This signal difference indicates an angle of arrival of the transmitted signal, and can therefore indicate an angle (e.g., an azimuth) of the mobile device with respect to the other device (and thus whether the mobile device is oriented toward the other device). Example types of differences in a signal detected by multiple antennas include phase difference, timing difference, and gain difference. Although this document largely references computations relating to a phase difference in a signal received at two different antennas, the signal difference that is involved in various electronic and/or computational processes may additionally or alternatively be a timing difference or a gain difference.

A tilt in the orientation of the mobile device (e.g., in a direction transverse to the azimuth) can introduce an error between: (i) the angle of arrival indicated by the phase difference of the signal, and (ii) a true angle of the mobile device with respect to the other device. A computing system can modify the identified phase difference based on the tilt of the mobile device. Doing so can generate a compensated phase difference that indicates an angle of arrival that more closely approximates a true angle of the mobile device with respect to the other device.

Should the computing system determine that the mobile device performed the pointing gesture, and is oriented toward the other device (e.g., during or upon completion of the pointing gesture), the computing system can initiate a cooperative activity between the mobile device and the other device, such as: (1) casting media from the mobile device to the other device, or vice versa; (2) unlocking the other device, or vice versa; (3) sharing a file indicated by the mobile device with the other device, or vice versa; and/or (4) activating an ability to control the other device with the mobile device, or vice versa.

Implementations of the technology described in this disclosure can, in certain instances, realize one or more of the following advantages. A user may be able to activate interaction between a handheld device and another device by moving the handheld device, without having to press user interface controls of the handheld device (or with pressing fewer user interface controls than required using alternative mechanisms to activate such interaction). A user may orient a user device toward another device to select the other device, rather than having to select the other device from a list of devices (e.g., a list of nearby devices).

Phase difference of transmissions between devices may be analyzed to determine whether the devices are oriented toward each other, and compensating for a non-standard orientation of the mobile device can overcome angle of arrival errors that may otherwise be present. Such technologies can save user time and facilitate device interaction among users with limited dexterity.

As additional description to the embodiments described below, the present disclosure describes the following embodiments.

Embodiment 1 is a computer-implemented method for detecting a mobile device pointing gesture toward another device. The method comprises determining that a mobile computing device physically moved in a manner that satisfies criterion for a pointing gesture; determining that the pointing gesture is oriented toward a particular device, including by: (i) receiving, by a receiving device of the mobile computing device and the particular device, a signal that was transmitted by a transmitting device of the mobile computing device and the particular device, using a first antenna of the receiving device and a second antenna of the receiving device; (ii) determining an indication of a signal difference between receipt of the signal by the first antenna and the second antenna; (iii) identifying a physical orientation of the mobile computing device; (iv) determining an indication of a compensated signal difference by adjusting the indication of the signal difference based on the physical orientation of the mobile computing device; and (v) determining that the indication of the compensated signal difference satisfies criterion for the pointing gesture being oriented toward the particular device; and initiating a particular activity between the mobile computing device and the particular device, based on having determined both that (a) the mobile computing device physically moved in the manner that satisfies the criterion for the pointing gesture, and (b) the pointing gesture is oriented toward the particular device.

Embodiment 2 is the computer-implemented method of embodiment 1, wherein the indication of signal difference between receipt of the signal by the first antenna and the second antenna comprises: an indication of a phase difference between receipt of the signal by the first antenna and the second antenna; an indication of a timing difference between receipt of the signal by the first antenna and the second antenna; or an indication of a gain difference between receipt of the signal by the first antenna and the second antenna.

Embodiment 3 is the computer-implemented method of any one of embodiments 1 and 2, wherein identifying the physical orientation of the mobile computing device includes identifying an amount that the mobile computing device is tilted away from a vertical orientation.

Embodiment 4 is the computer-implemented method of embodiment 3, wherein determining the indication of the compensated signal difference includes accessing first compensation data that correlates the amount that the mobile computing device is tilted away from the vertical orientation to an amount of error in the indication of the signal difference.

Embodiment 5 is the computer-implemented method of embodiment 4, wherein: the mobile computing device comprises the receiving device and the particular device comprises the transmitting device; the first compensation data indicates how to compensate the signal difference for signal transmissions between a combination of a first type of device that includes the mobile computing device and a second type of device that includes the particular device; the method comprises: (i) in receiving, by the mobile computing device, a second signal that was transmitted by a second transmitting device, using the first antenna and the second antenna of the mobile computing device; (ii) determining a second indication of a signal difference between receipt of the second signal by the first antenna and the second antenna; and (iii) determining a second indication of a compensated phase difference by adjusting the second indication of the signal difference based on the physical orientation of the mobile computing device, including by applying second compensation data that indicates how to compensate phase for signal transmissions between a combination of the first type of device that includes the mobile computing device and a third type of device that includes the second transmitting device, the third type of device being different from the second type of device and the second compensation data being different from the first compensation data; and the indication of the compensated signal difference represents a lesser signal difference than the second indication of the compensated signal difference, such that the pointing gesture is determined to be oriented toward the particular device and not the second transmitting device.

Embodiment 6 is the computer-implemented method of any one of embodiments 1 through 5, wherein determining that the mobile computing device physically moved in the manner that satisfies the criterion for the pointing gesture includes: (a) determining that the mobile computing device physically tilted away from a vertical orientation by a threshold amount of tilt; and (b) determining that the mobile computing device physically moved laterally a threshold amount of lateral movement.

Embodiment 7 is the computer-implemented method of embodiment 6, wherein the mobile computing device physically tilted away from the vertical orientation the threshold amount of tilt at least partially while the mobile computing device physically moved laterally the threshold amount of lateral movement.

Embodiment 8 is the computer-implemented method of any one of embodiments 6 and 7, wherein determining that the mobile computing device physically tilted away from the vertical orientation and physically moved laterally the threshold amount of lateral movement is based on measurements from one or more orientation or movement sensors of the mobile computing device.

Embodiment 9 is the computer-implemented method of any one of embodiments 6 through 8, wherein determining that the mobile computing device physically moved in the manner that satisfies the criterion for the pointing gesture includes: (c) determining that the mobile computing device satisfied criterion for remaining stationary and tilted, after the mobile computing device physically tilted away from the vertical orientation and physically moved laterally, wherein the receiving device receives the signal at least partially while the mobile computing device satisfied the criterion for remaining stationary and tilted.

Embodiment 10 is the computer-implemented method of any one of embodiments 1 through 9, wherein: the mobile computing device comprises the receiving device and the particular device comprises the transmitting device, such that the mobile computing device receives the signal and the signal was transmitted by the particular device.

Embodiment 11 is the computer-implemented method of embodiment 10, wherein: the mobile computing device includes a top end, a bottom end opposite the top end, a front face that presents a display device and that is located between the top end and the bottom end, and a back face opposite the front face; and the first antenna and the second antenna are positioned to receive signals at the back face of the mobile computing device, are located between the top end and the bottom end at a same vertical height within the mobile computing device, and are laterally separated from each other at the vertical height.

Embodiment 12 is the computer-implemented method of embodiment 11, wherein: determining that the mobile computing device physically moved in the manner that satisfies the criterion for the pointing gesture includes determining that the mobile computing device tilted away from a vertical orientation, such that the back face titled downward and the bottom end tilted upward.

Embodiment 13 is the computer-implemented method of any one of embodiments 1 through 12, wherein the particular activity includes casting media that is playing or is queued for play by the mobile computing device for playback by the particular device.

Embodiment 14 is the computer-implemented method of embodiment 13, wherein initiating the particular activity includes presenting, by a touchscreen display device of the mobile computing device, a user-selectable prompt to begin casting the media.

Embodiment 15 is the computer-implemented method of any one of embodiments 1 through 14, wherein the signal received by the receiving device and transmitted by the transmitting device comprises an ultra-wideband signal.

Embodiment 16 is directed to one or more computer-readable devices including instructions thereon that, when executed by one or more processors, cause performance of actions according to the method of any one of embodiments 1 through 15.

Embodiment 17 is directed to a mobile computing device comprising: a first antenna; a second antenna; one or more processors; one or more computer-readable devices including instructions that, when executed by the one or more processors, cause performance of actions according to the method of any one of embodiments 1 through 15.

The details of one or more implementations are set forth in the accompanying drawings and the description below. Other features, objects, and advantages will be apparent from the description and drawings, and from the claims.

### DESCRIPTION OF DRAWINGS

FIG. 1 illustrates a mobile device pointing gesture toward another device, and how such a user input mechanism can trigger interaction between the devices.

FIG. 2 illustrates an example mobile device pointing gesture.

FIGS. 3A-C show graphs that illustrate characteristics of a mobile device during a pointing gesture.

FIG. 4 illustrates how a mobile device can include antennas that are used to determine an orientation of the mobile device with respect to another device that is transmitting a signal.

FIG. 5 shows how tilting a mobile device can introduce error into an angle of arrival indicated by a determined phase difference.

FIG. 6 shows how the angle of arrival errors may differ for a different combinations of devices.

FIGS. 7A-D show a flowchart of operations for detecting a mobile device pointing gesture toward another device.

FIG. 8 is a conceptual diagram of a system that may be used to implement the systems and methods described in this document.

FIG. 9 is a block diagram of computing devices that may be used to implement the systems and methods described in this document, as either a client or as a server or plurality of servers.

Like reference symbols in the various drawings indicate like elements.

### DETAILED DESCRIPTION

This document generally describes detecting a mobile device pointing gesture toward another device.

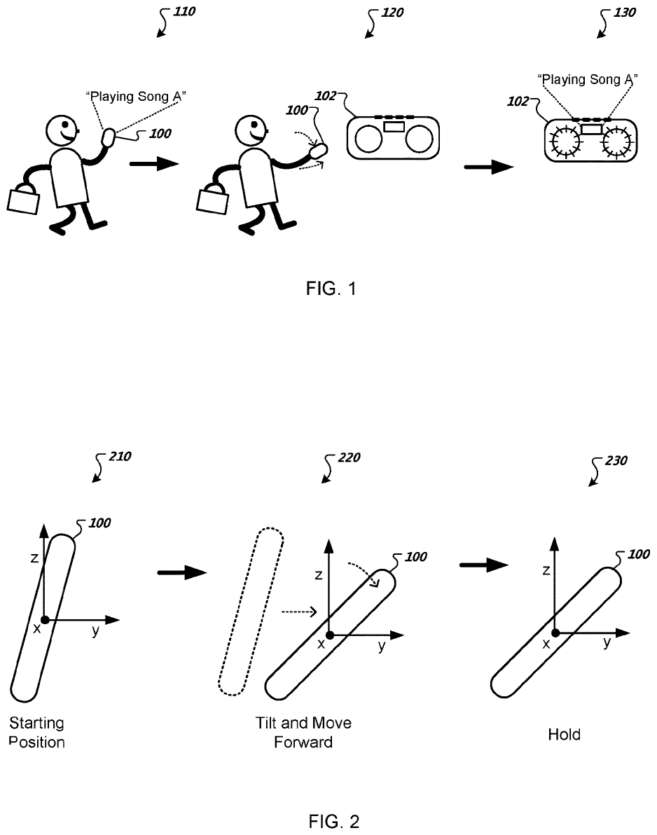

FIG. 1 includes three diagrams 110, 120, and 130 that illustrate a mobile device pointing gesture toward another device, and how such a user input mechanism can trigger interaction between the devices.

Diagram 110 shows a user holding a mobile device 100 (e.g., a smartphone), while the mobile device 100 is “Playing Song A”.

Diagram 120 illustrates the user pointing the mobile device 100 toward a speaker device 102, by tilting the top of the device away from the user toward the speaker device 102, and by moving the entire device 102 laterally in the same general direction toward the speaker device 102.

The mobile device 100 or another computing system may analyze movement of the mobile device 100 and characteristics of a wireless signal transmitted between the mobile device 100 and the speaker device 102, to determine that the user is pointing the mobile device 100 in a manner that satisfies criteria for a pointing gesture toward the speaker device 102.

Diagram 130 illustrates the speaker device 102 “Playing Song A”, as a result of the song being “cast” from the mobile device 100 to the speaker device 102. The casting of the song may be triggered by user performance of the pointing gesture toward the speaker device 102.

FIG. 2 includes three diagrams 210, 220, and 230 that illustrate an example mobile device pointing gesture.

Diagram 210 illustrates how the pointing gesture may begin with a reference state in which the mobile device 100 holds a pose for a certain period of time (e.g., a pose in which the device is oriented vertical or near vertical with minimal movement). Determining that the mobile device 100 remains in the pose may include determining that the mobile device 100 has not rotated or laterally moved more than threshold amounts specified by criteria, for a period of time specified by criteria.

Diagram 220 illustrates how the mobile device 100 both tilts about an x axis and moves laterally along a y axis during the pointing gesture. The tilting and movement may occur at least partially at the same time (e.g., with the tilting beginning before the lateral movement, and the lateral movement continuing after the tilting ends).

Diagram 230 illustrates how the pointing gesture may end by remaining in an ending pose for a period of time (e.g., at least 0.2 seconds).

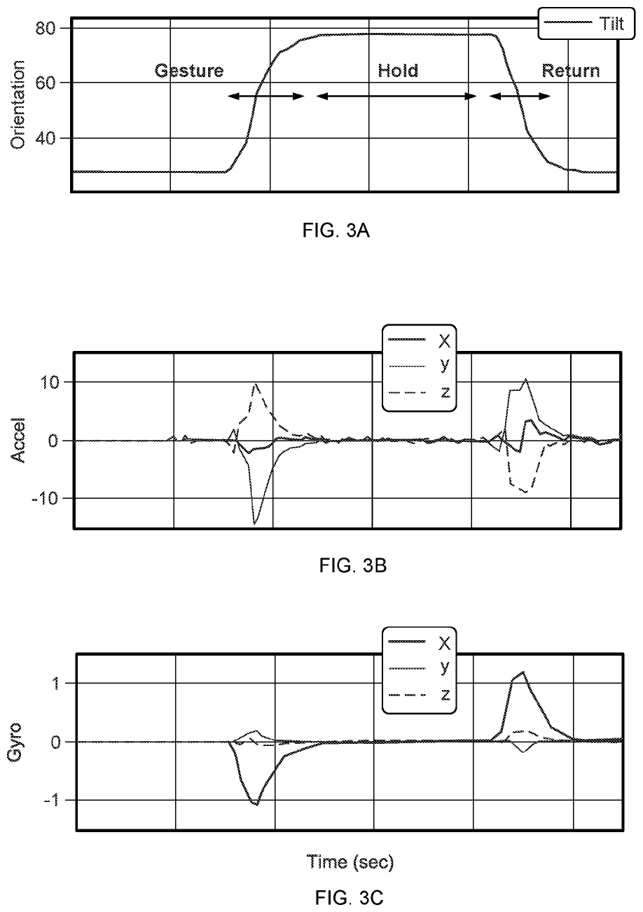

FIGS. 3A-C show graphs that illustrate characteristics of the mobile device 100 during a pointing gesture.

FIG. 3A shows how an example pointing gesture can include three parts: (1) A “Gesture” part, in which a user tilts the mobile device 100; (2) A “Hold” part, in which the user holds the mobile device 100 in the tilted manner; and (3) A “Return” part, in which the user un-tilts the mobile device 100 to return the mobile device 100 to its starting position.

The two-part pointing gestures illustrated in FIGS. 1-2 may represent the entire gesture, or may represent the first two parts of the three-part pointing gesture illustrated by FIG. 3A.

FIG. 3B shows acceleration measurements for the three-part pointing gesture of FIG. 3A. The y-axis line represents acceleration in a lateral direction extending outward away from a user, in a direction in which the user if facing (although FIG. 3B indicates movement forward as negative acceleration, due to an orientation of the sensor in the mobile device). The y-axis line illustrates large acceleration during the first part of the pointing gesture as the mobile device 100 moves laterally, and a similarly large acceleration in a reverse direction during the third part of the pointing gesture as the user pulls the mobile device 100 back to the user.

The z-axis line represents acceleration along a vertical axis, such as a direction in which gravity acts. Device movement along this axis occurs due to the tilting of the mobile device 100 (e.g., tilting the top end forward and down). The z-axis line illustrates acceleration in one direction during the first part of the pointing gesture as the mobile device 100 is tilted forward, and a similar acceleration in the opposite direction during the third part of the pointing gesture as the mobile device 100 is tilted backward.

The x-axis line represents side-to-side movement, along an axis perpendicular to a direction in which the user is pointing (e.g., an axis extending between the user's left and the user's right when holding the mobile device 100 in the resting orientation). The x-axis line illustrates little acceleration because the user is not moving the mobile device to his left or right during the pointing gesture.

FIG. 3C shows gyroscopic orientation measurements for the three-part pointing gesture of FIG. 3A. As indicated with respect to FIG. 3B, the x axis extends from the user's left to the user's right. Tilting the mobile device 100 forward (with the top end of the device 100 moving forward and down and the bottom end of the device 100 moving backward and up) corresponds to the mobile device 100 twisting about the x axis. Accordingly, FIG. 3C shows a significant x-axis change during the first and third parts of the pointing gesture. The y-axis and z-axis lines do not show substantial change throughout the pointing gesture, because the mobile device 100 does not substantially twist about either of these axes during the pointing gesture.

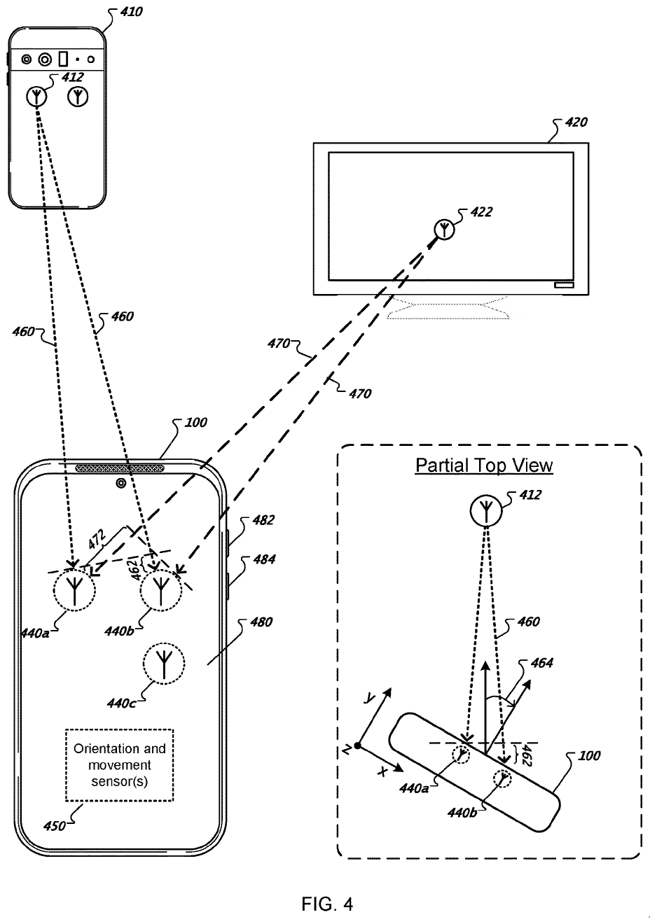

FIG. 4 illustrates how the mobile device 100 includes antennas that can be used to determine an orientation of the mobile device 100 with respect to another device that is transmitting a signal.

In this illustration, mobile device 100 includes at least two antennas 440a-b that are housed by the mobile device 100 and are spaced apart from each other along the x-axis illustrated by FIG. 2 (e.g., and not spaced apart from each other along the y and/or axes). The antennas 440a-b may be configured within the mobile device 100 to be more sensitive to signals received by a back face of the mobile device than a front face of the mobile device that includes a touchscreen display device 480.

The antennas 440a-b may receive a signal 460 that is transmitted by an antenna 412 of device 410. The antennas 440a-b may receive the signal 460 at different times, due differing distances between the transmitting antenna 412 and the receiving antennas 440a-b. This difference in time, known as a phase delay or phase difference, is illustrated in FIG. 4 by item 462.

At a same or different time, another device 420 may transmit a signal 470 using antenna 422. The phase difference among receipt of signal 470 by antennas 440a-b is illustrated by item 472. The phase difference in receipt of the signal 470 is greater than the phase difference in receipt of signal 460, indicating that the mobile device 100 more directly faces device 410 than device 420.

The phase difference can indicate the angle of arrival of the incoming signal. The angle of arrival can indicate an angle of the receiving device with respect to the transmitting device in certain conditions. For example, the angle 464 between the receiving device 100 and the transmitting antenna 412 can be determined based on the phase difference between receipt of signal 460 by antennas 440a-b (see item 462, illustrated the phase difference).

The mobile device 100 includes one or more orientation and movement sensors 450, which may include any combination of a one or more inertial measurement units, one or more gyroscopes, one or more accelerometers, and one or more magnetometers.

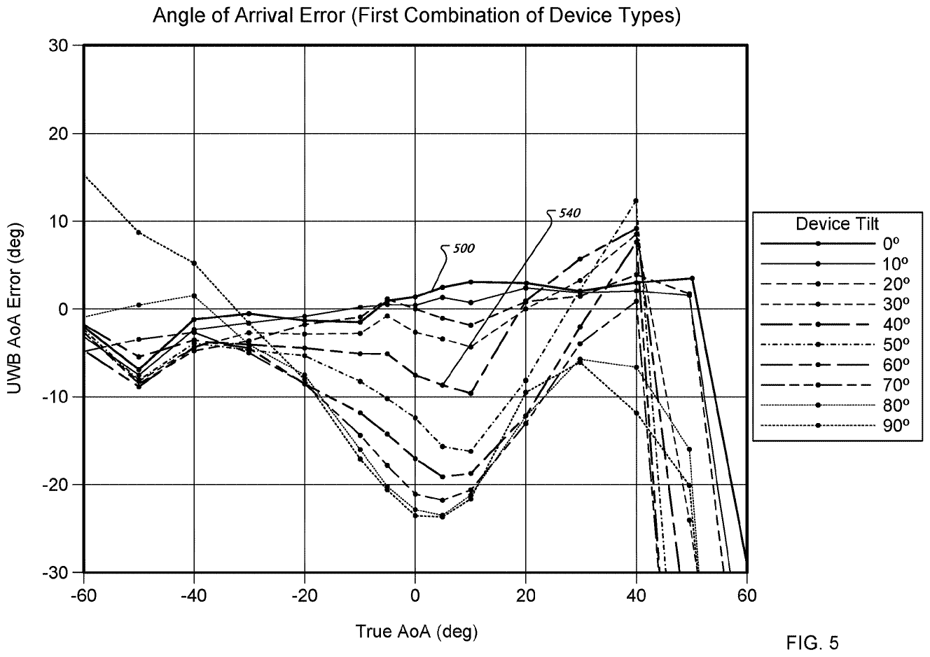

FIG. 5 shows how tilting a mobile device can introduce error into an angle of arrival indicated by a determined phase difference. For example, FIG. 5 illustrates how a device tilted at 0 degrees (see line 500) has relatively little error/difference between the angle of arrival indicated by the phase difference and the true/physical angle between the transmitting and receiving devices. But when the device is tilted to 40 degrees (see line 540), there is an error of approximately 8 degrees between the angle of arrival indicated by the phase difference and the true angle between the transmitting and receiving device.

A computing system can determine the tilt of the mobile device 100 (e.g., using the one or more orientation and movement sensors 450 of the mobile device 100), and use the determined tilt to select an error value from the data illustrated in FIG. 5. This error value can be applied to the determined phase difference—or angle of arrival information determined therefrom—to generate a compensated phase difference that more closely indicates the true angle between the transmitting and receiving devices.

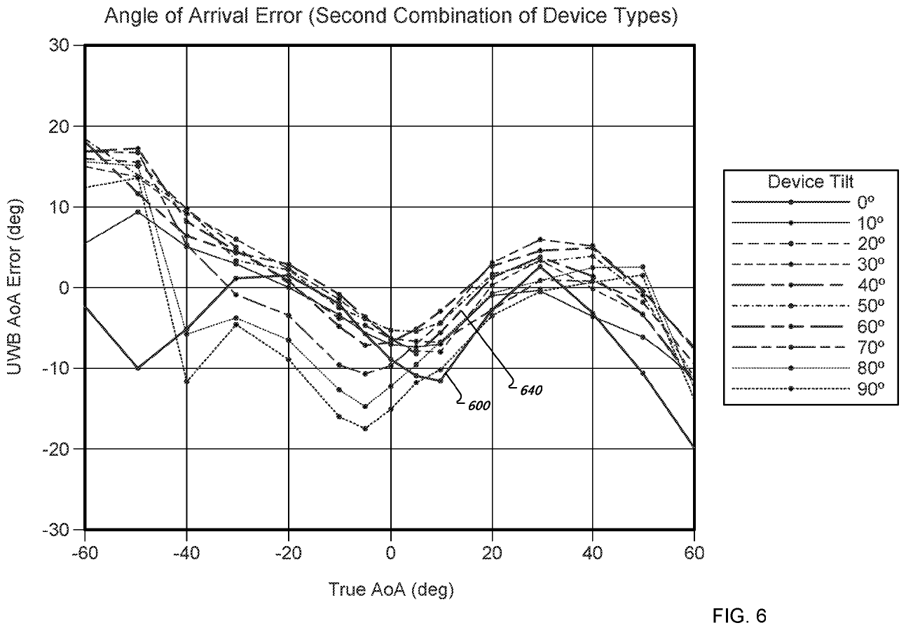

FIG. 6 shows how the angle of arrival errors illustrated in FIG. 5 may be specific to a combination of devices. For example, FIG. 5 may illustrate angle of arrival errors between a type of devices represented by device 100 and a type of device represented by device 410 (e.g., which may be the same type of transmitting and receiving devices). FIG. 6 may illustrate angle of arrival errors between the type of device represented by device 100 and the type of device represented by device 420.

FIG. 6 shows how a device tilted at 0 degrees (see line 600) has an error of approximately 9 degrees between the angle of arrival indicated by the phase difference and the true angle between the transmitting and receiving device (in comparison to the error of approximately 0 degrees illustrated by FIG. 5). When the device is tilted to 40 degrees (see line 640), there is an error of approximately 6 degrees.

The data illustrated in FIGS. 5 and 6 indicate an angle of arrival error as a function of a true angle of arrival (e.g., a physical orientation of a mobile device with respect to a transmitting antenna). This data may be generated based on measurements performed using the same configuration of devices, based on differences in signals received between at least two antennas of the receiving device (e.g., phase difference, timing difference, and/or gain difference).

The different errors between different types of devices can result from different antenna types and configurations, and different types of antenna shielding. For example, the transmitting antenna 412 may have vertical polarization, while antennas 440a-b of receiving device 100 may have a combination of vertical and horizontal polarization. These different antenna configurations can introduce errors in angle of arrival, and the error may change as the device orientations change with respect to each other.

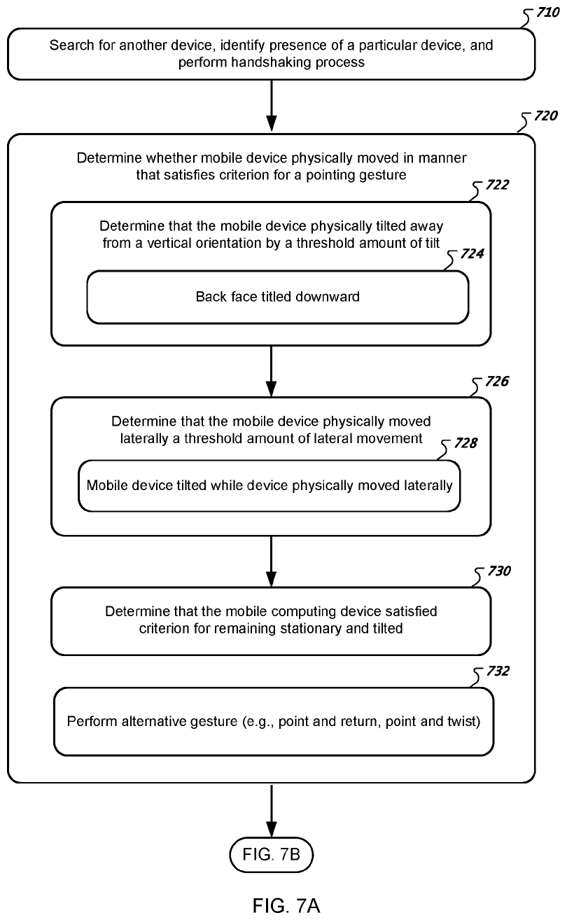

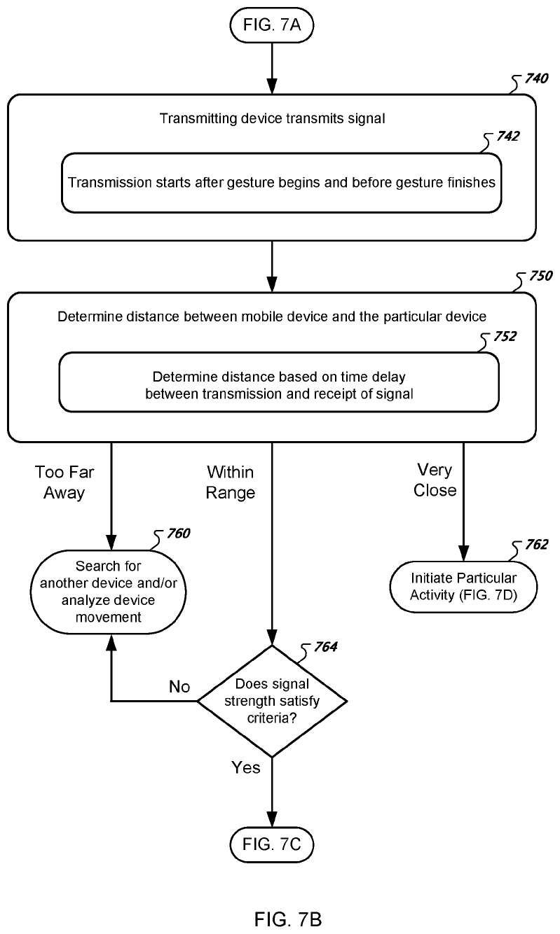

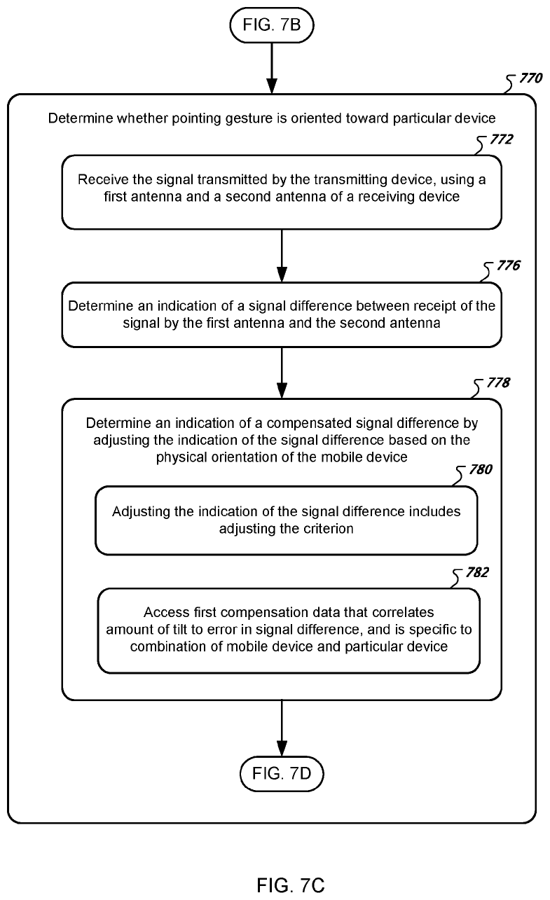

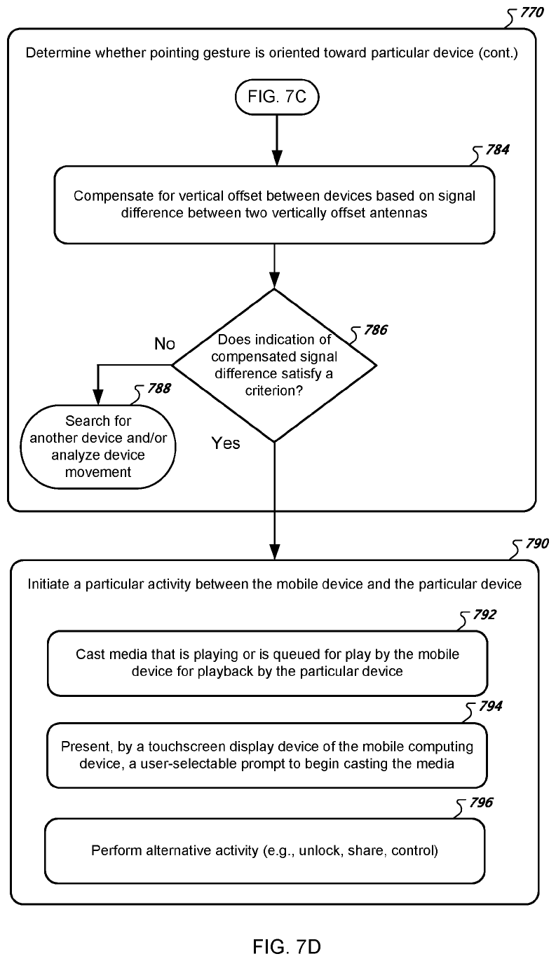

FIGS. 7A-D show a flowchart of operations for detecting a mobile device pointing gesture toward another device.

At box 710, a computing system searches for another device, identifies presence of a particular device, and performs a handshaking process with the particular device. The operations described by the computing system may be performed by the mobile device 100, the particular device, yet another computing system (e.g., a cloud computing system), or a combination of one or more of these systems. For example, the mobile device 100 may regularly search for presence of another device. This searching may be through Bluetooth communication, ad hoc or a shared Wi-Fi network, ultra wideband, or some other communication mechanism in which two devices may communicate with each other.

A user may carry the mobile device 100 into a room in which device 420 is located, the mobile device 100 may identify a communication from the television 420, and the mobile device 100 may perform a handshaking process with the television 420 in order to negotiate protocols for further device-to-device communications. The mobile device 100 periodically searches for other devices, potentially performing handshaking processes with multiple such devices that are configured to coordinate with the mobile device 100 regarding the pointing gesture.

At box 720, a computing system determines whether the mobile device physically moved in a manner that satisfies criterion for a pointing gesture. For example, the mobile device 100 may regularly analyze measurements from the one or more orientation and movement sensors 450, and determine therefrom whether device movement matches a device pointing gesture. This determination may include multiple portions, such as the operations of boxes 722 through 732.

At box 722, the computing system determines that the mobile device physically tilted away from a vertical orientation by a threshold amount of tilt. Tilting may occur by rotation about the x axis (see FIG. 2), as determined by analysis of measurements by the one or more orientation and movement sensors 450. The determination that tilting occurred may involve determining that the mobile device 100 tilted at least a certain amount about a certain axis within a certain period of time, and that rotation about other axes were minimal (e.g., less than threshold amounts).

At box 724, the tilting includes a back face of the mobile device 100 tilting downward to more fully orient towards a ground. For example, the back face of mobile device 100 may be a face opposite the touchscreen display device 480. The back face may not include a display, and may be separated from a front face of the mobile device 100 by a peripheral wall of the mobile device 100, from which multiple physically-actuated buttons 482 and 484 extend.

At box 726, the computing system determines that the mobile device 100 physically moved laterally a threshold amount of lateral movement. For example, the mobile device 100 may analyze measurements by the one or more orientation and movement sensors 450 and determine therefrom that the mobile device 100 has moved in its entirety in a particular direction (e.g., that a center of volume of the mobile device has moved laterally in the particular direction), and by an amount that satisfies criteria. The criteria may include the lateral movement of the mobile device 100 being in a direction that a top of the mobile device is tilted forward, such that the lateral movement and the tilting together satisfy criteria for a user pointing the mobile device 100.

At box 728, the mobile device tilting occurred while the device physically moved laterally. For example the mobile device 100 may determine that the tilting and the lateral movement occurred at least partially at the same time (e.g., over 30%, 50%, or 80% of the lateral movement occurred while the device 100 was tilting.

At box 730, the computing system determines that the mobile computing device satisfied criterion for remaining stationary and tilted. For example, the mobile device 100 may determine that, after the mobile device 100 moved in a manner that satisfied the criteria for tilting and lateral movement, the mobile device 100 remained stationary. The stationary portion of the pointing gesture corresponds to a user holding the mobile device 100 in a tilted orientation, after the user pointed the mobile device 100 (e.g., by tilting and laterally moving the mobile device 100).

At box 732, the computing system is configured to determine that the mobile device physically moved in a manner that satisfies criterion for a gesture other than the pointing gesture discussed with reference to boxes 722-730. For example, the gesture alternatively is or includes a pointing gesture followed by a “return” movement, in which the mobile device tilts and laterally moves in directions that are opposite the “pointing” portion of the gesture. The gesture may alternatively include a pointing gesture followed by a “twist” about a vertical axis of the device 100 after the device 100 has tilted and moved forward laterally.

At box 740, a transmitting device transmits a signal. The transmitting device may be either of the mobile device 100 and the particular device 100 with which the mobile device 100 has performed a handshaking process. The receiving device would be the other device of the mobile device 100 and the particular device. The transmission and receipt of the signal may be to determine distance between the two devices and/or an orientation of the devices with respect to each other. In this illustration, the particular device serves as the transmitting device and the mobile device 100 serves as the receiving device, although the roles may be reversed. The transmitted signal may be a radio frequency signal (e.g., ultra wideband or Bluetooth) or an acoustic signal (in which case electroacoustic transducers may be used instead of antennas). For example, the transmitted signal may be transmitted in accordance with 802.15.4, a secure UWB ranging (and angle of arrival) standard.

At box 742, the transmission of the signal starts after the gesture begins, and before the gesture finishes. For example, upon the mobile device 100 determining that criteria for performing part of the pointing gesture has been completed (e.g., the user has begun tilting the mobile device 100 and begun laterally moving the mobile device 100), the mobile device 100 may send a command to the television 420 to begin transmitting a signal used for determination of relative distance and/or orientation between the devices. The television 420 may begin transmitting the signal 420 while the mobile device 100 has yet to complete performing its pointing gesture (e.g., the mobile still has to satisfy a remaining portion of the “pointing” and/or the “holding” portions of the gesture), such that upon completion of the gesture, the distance and/or orientation between the devices has already been computed or is in the process of being computed. In some implementations, the transmission of the signal begins after the tilting and movement portion of the gesture, and during the holding portion of the gesture In some implementations, the determination of whether the mobile device 100 is pointed toward the other device (see box 770, described below) before the hold portion of the gesture is complete, such that immediately determining that the mobile device 100 has been held a sufficient amount of time (or other criteria for completing the gesture has completed), the mobile device 100 and other device initiate the cooperative activity (see box 790, described below). In some implementations, the transmission of the signal does not begin until after the mobile device 100 has been determined to perform the pointing gesture.

At box 750, the computing system determines a distance between mobile device and the particular device. The distance determination may be based on various mechanisms, including time of signal transmission (see box 752), positions based on Global Positioning System measurements, and/or both devices being on a same communication network (e.g., WiFi) or within range of a short-range communication signal (e.g., Bluetooth).

At box 752, the distance is determined based on a time delay between transmission and receipt of the signal. For example, the mobile device 100 may receive the transmitted signal, and compare the time of receipt to a time of transmission to determine a time delay of signal transmission. This time delay of signal transmission can be correlated to a physical distance between the mobile device 100 and the television 420.

At box 760, responsive to the distance between the devices being determined to be beyond a threshold distance, the mobile device 100 continues searching for another device and/or analyzes mobile device movement. For example, the mobile device 100 may determine that the television 420 is too far away for the pointing gesture to be toward the televisions 420. As a result, the mobile device 100 may determine whether another remote device satisfies the distance criteria (e.g., if there is another device transmitting responsive to the mobile device 100 having detected at least part of a pointing gesture). Additionally or alternatively, the mobile device 100 may terminate operations associated with the pointing gesture, await detection of another pointing gesture, and/or search for other nearby devices with which to establish communication sessions.

At box 762, responsive to the distance between the devices being determined to be within a given distance, the computing system initiates the particular activity, by jumping to the operations of box 790 (FIG. 7D). For example, the mobile device 100 may determine that the television 420 is within a thirty-centimeter threshold, and as a result may initiate “casting” of media from the mobile device 100 to the television 420. The casting may occur without a computing system determining whether the pointing gesture is oriented toward the television 770 (e.g., without performing the operations of boxes 770-786), due to the close proximity of the devices. The determination that the distance is within a given distance may be based on a signal received by a single antenna of the mobile device 100 (e.g., such that the mobile device 100 may not need to receive the signal with multiple antennas to determine that the distance is within the given distance).

At box 764, responsive to the determined distance satisfying criteria for the mobile device 100 and television 420 being within range of each other, the computing system determines whether a strength and/or quality of a signal used for determining orientation of the devices to each other satisfies criterion. For example, the mobile device 100 may determine whether the signal of box 740 satisfies signal strength and/or quality criteria. Should the signal not satisfy signal strength and/or quality criteria, the operations of box 760 may be performed. The signal strength and/or quality may be analyzed, because the mobile device 100 may receive a low-strength and poor-quality signal when the mobile device is angled away from the television 420 (e.g., beyond 40 degrees from a direct orientation).

In some implementations, the computing system does not perform the distance determination operations of boxes 750-752 or the signal strength/quality analysis of box 764. In other words, the computing system may not perform the distance “gating” process of boxes 750-752 or the signal strength “gating” process of box 764.

At box 770, the computing system determines whether the pointing gesture is oriented toward the particular device. For example, the mobile device 100 may analyze characteristics of an electromagnetic or sound signal transmitted by the television 420, to determine whether the mobile device 100 is oriented toward the television 420 (e.g., during the “hold” portion of the pointing gesture).

At box 772, the receiving device receives the signal transmitted by the transmitting device, using a first antenna and a second antenna of the receiving device. For example, the mobile device 100 may include two antennas 440a-b that are located in a side-by-side horizontal configuration, to determine a horizontal angle of arrival of a signal when the mobile device 100 is pointed by a user.

At box 776, the computing system determines an indication of a signal difference between receipt of the signal by the first antenna and the second antenna. For example, the mobile device 100 may determine a difference in phase difference between when a given portion of the signal transmitted by the television 420 is received by the first antenna 440a and when the signal is received by the second antenna 440b. This phase difference can be used to determine an angle of arrival of the signal, and therefore an angle of the mobile device 100 with respect to the television 420. The indication of the signal difference can include, for example, the phase difference itself or data computed therefrom, such as a determined angle of arrival. As discussed above, the tilting of the mobile device 100 toward to the television 420 can introduce a deterministic error into the phase difference. The operations of box 778 (below) compensate for device tilt.

At box 778, the computing system determines an indication of a compensated timing difference by adjusting the indication of the timing difference based on the physical orientation of the mobile device. For example, the mobile device 100 may: (1) determine an amount that the device is tilted away from vertical (e.g., an amount rotated about the x axis of the device); (2) access compensation data such as that illustrated in FIG. 5; (3) identify an amount of phase difference or angle of arrival error based on applying the amount of tilt to the compensation data; and (4) modify the indication of the phase difference based on the identified error to determine the indication of the compensated phase difference. The indication of the compensated signal difference can be a compensated phase difference or data computed therefrom, such as a compensated angle of arrival.

At box 780, adjusting the indication of the signal difference includes adjusting the criterion. In other words, determining the indication of the compensated signal difference can involve adjusting values other than the signal different itself or an angle of arrival computer therefrom, so long as the effective result corresponds to adjusting the indication of the signal difference.

At box 782, the computing system accesses first compensation data that correlates an amount of mobile device tilt to a corresponding error in signal difference. The first compensation data may be specific to a combination of the mobile device and the particular device. For example, the compensation data may be specific to both a type of the transmitting device and/or the receiving device, due to characteristics of the transmitting and receiving antennas and their installation in the respective devices. As such, the computing system may have access to multiple sets of compensation data (e.g., including the two sets illustrated in FIGS. 5 and 6), and may select a given set of compensation data based on the two devices that are in communication.

At box 784, the computing system compensates for a vertical offset between the mobile device 100 and the particular device, based on a signal difference between two vertically offset antennas. For example, the operations of boxes 770-782 may be based on the mobile device 100 and the television 420 being located at approximately a same height off the ground, so that a certain tilt of the mobile device 100 (e.g., 30 degrees) matches a relative tilt between the mobile device 100 and the television 420. Should the television 420 be located at a different height off the ground (e.g., up high on a wall), the computing system can further compensate for the difference in height.

This compensation can include the mobile device 100 determining a signal difference between receipt of the signal (or another signal) between two vertically-aligned antennas of the mobile device 100, such as antenna 440b and 440c (see FIG. 4). This vertical phase difference can be used to further modify the indication of the compensated phase difference based on vertical compensation data, or can be used to modify the identified tilt of the mobile device 100 before the tilt is used to compensate for errors in the phase difference identified by the horizontally-aligned antennas.

At box 786, the computing system determines whether the indication of the compensated signal difference satisfies a criterion for the pointing gesture being oriented toward the particular device. For example, the compensated signal difference may need to correspond to a true angle of arrival of 30, 20, 15, or 10 degrees or less in either direction between the mobile device 100 and the television 420, in order for the mobile device 100 to determine that the pointing gesture is oriented toward the television 420 and not in some other direction.

At box 788, responsive to the computing system determining that the mobile device 100 was not pointed toward the television 420, the mobile computing device continues to search for another device, analyze mobile device movement, and/or determine whether the mobile device 100 is pointed toward a different device.

At box 790, responsive to the computing system determining that (1) the mobile device 100 moved in a manner that satisfies criteria for a pointing gesture, (2) the pointing gesture being oriented toward the particular device, the computing system initiates the particular activity between the mobile device and the particular device. If the mobile device 100 is determined to be pointing toward multiple devices (e.g., performing the operations of box 770 for each of multiple devices), the computing system may designate a device to which the indication of the compensated phase difference is closest to 0 as a device with which to initiate a particular activity.

At box 792, initiating the particular activity includes the mobile device casting media that is playing, or is queued for play by the mobile device, for playback by the particular device. For example, the mobile device 100 may send a command directly to the television 420, or indirectly through an intermediate device, to cause the television 420 to begin playing media that was being played by the mobile device 100. The mobile device 100 may transmit the media content (e.g., audio and/or video) to the television 420, or the mobile device 100 may transmit a source address of the media to the television 420, so that the television 420 can access media content from the source. The mobile device 100 may stop casting the media, although user input controls on the mobile device 100 for pausing and/or switching to different media content may remain active so that a user can control playback by the television 420 using the mobile device 100.

At box 794, initiating the particular activity includes presenting, by a touchscreen display device of the mobile computing device, a user-selectable prompt to begin casting the media. For example, upon confirmation that the mobile device 100 was pointed toward the television 420, the mobile device 100 may present a pop-up button that a user can select to confirm that the media should be cast to the television 420. In some embodiments, the particular activity may fully commence without further user input beyond performing the pointing gesture toward the particular device.

At box 796, initiating the particular activity includes performing an alternative activity. Casting is provided as an example, and completion of a gesture pointed toward another device may initiate another type of activity. For example, a user may point their mobile device 100 to another device to unlock the other device (e.g., a laptop or car), share a file from the mobile device 100 to the other device, or activate user-input controls on the mobile device 100 for controlling operation of the other device (e.g., point toward the television 420 to activate a user interface on the mobile device 100 for switching channels).

In some implementations, the computing system continues to monitor the mobile device 100 after initiating the particular activity. For example, the computing system may continue to monitor an orientation of the mobile device 100, movement of the mobile device 100, and/or an angle of the mobile device 100 with respect to the other device. Such continued feedback can facilitate further interaction between the mobile device 100 and the other device.

For example, pointing the mobile device 100 toward a television may trigger control of the television using the mobile device 100, and continued monitoring can enable a user of the mobile device 100 to adjust a volume of the television by moving the pointed mobile device 100 up or down. In some implementations, movement of the mobile device 100 enables that device to be used as a pointer or a controller (e.g., movement to the side reverses or forwards media content; double pointing pauses and plays media content).

In implementations in which the mobile device 100 comprises a watch, a user may be able to point the watch at another device to control the other device. For example, pointing at the other device brings up control elements on the watch display for controlling the other device, raising the watch up or down adjusts volume up or down, and/or shaking the watch plays or pauses the media content.

In some implementations, the computing system performs the detection process described in this document for each of multiple devices in a room, and provides an indication on the mobile device 100 regarding each of the multiple devices and their position with respect to the mobile device 100. For example, a user interface can display an icon for each such device, with an icon for a “pointed-to device” in a center of the user interface, and icons for one or more other devices arranged in the user interface at locations that represent physical locations of the corresponding devices with respect to the pointed-to-device in the real world. Such feedback can provide a user of the mobile device 100 confidence in their selection and spatial browsability.

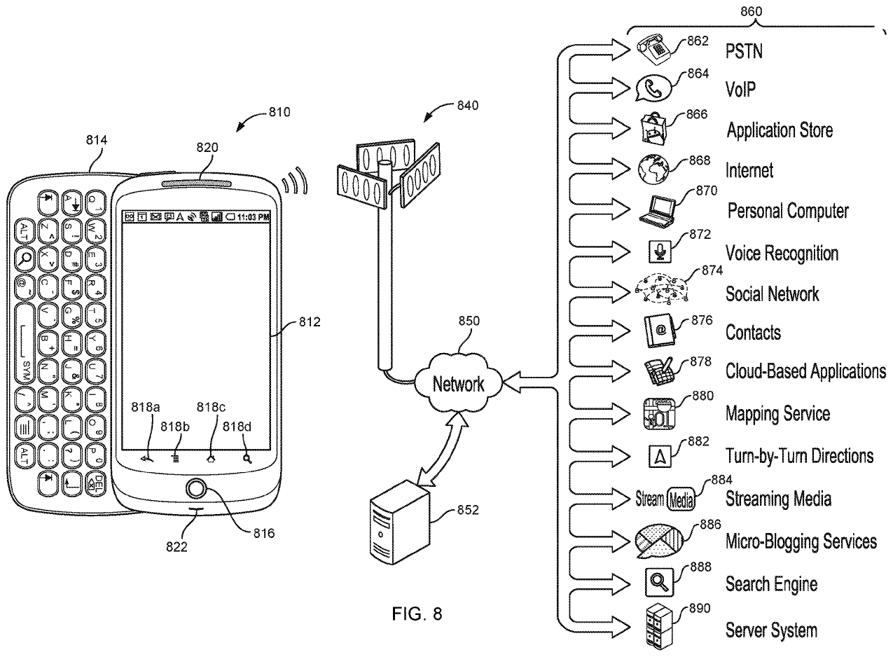

Referring now to FIG. 8, a conceptual diagram of a system that may be used to implement the systems and methods described in this document is illustrated. In the system, mobile computing device 810 can wirelessly communicate with base station 840, which can provide the mobile computing device wireless access to numerous hosted services 860 through a network 850.

In this illustration, the mobile computing device 810 is depicted as a handheld mobile telephone (e.g., a smartphone, or an application telephone) that includes a touchscreen display device 812 for presenting content to a user of the mobile computing device 810 and receiving touch-based user inputs and/or presence-sensitive user input (e.g., as detected over a surface of the computing device using radar detectors mounted in the mobile computing device 510). Other visual, tactile, and auditory output components may also be provided (e.g., LED lights, a vibrating mechanism for tactile output, or a speaker for providing tonal, voice-generated, or recorded output), as may various different input components (e.g., keyboard 814, physical buttons, trackballs, accelerometers, gyroscopes, and magnetometers).

Example visual output mechanism in the form of display device 812 may take the form of a display with resistive or capacitive touch capabilities. The display device may be for displaying video, graphics, images, and text, and for coordinating user touch input locations with the location of displayed information so that the device 810 can associate user contact at a location of a displayed item with the item. The mobile computing device 810 may also take alternative forms, including as a laptop computer, a tablet or slate computer, a personal digital assistant, an embedded system (e.g., a car navigation system), a desktop personal computer, or a computerized workstation.

An example mechanism for receiving user-input includes keyboard 814, which may be a full qwerty keyboard or a traditional keypad that includes keys for the digits ‘0-9’, ‘*’, and ‘#.’ The keyboard 814 receives input when a user physically contacts or depresses a keyboard key. User manipulation of a trackball 816 or interaction with a track pad enables the user to supply directional and rate of movement information to the mobile computing device 810 (e.g., to manipulate a position of a cursor on the display device 812).

The mobile computing device 810 may be able to determine a position of physical contact with the touchscreen display device 812 (e.g., a position of contact by a finger or a stylus). Using the touchscreen 812, various “virtual” input mechanisms may be produced, where a user interacts with a graphical user interface element depicted on the touchscreen 812 by contacting the graphical user interface element. An example of a “virtual” input mechanism is a “software keyboard,” where a keyboard is displayed on the touchscreen and a user selects keys by pressing a region of the touchscreen 812 that corresponds to each key.

The mobile computing device 810 may include mechanical or touch sensitive buttons 818a-d. Additionally, the mobile computing device may include buttons for adjusting volume output by the one or more speakers 820, and a button for turning the mobile computing device on or off. A microphone 822 allows the mobile computing device 810 to convert audible sounds into an electrical signal that may be digitally encoded and stored in computer-readable memory, or transmitted to another computing device. The mobile computing device 810 may also include a digital compass, an accelerometer, proximity sensors, and ambient light sensors.

An operating system may provide an interface between the mobile computing device's hardware (e.g., the input/output mechanisms and a processor executing instructions retrieved from computer-readable medium) and software. Example operating systems include ANDROID, CHROME, IOS, MAC OS X, WINDOWS 7, WINDOWS PHONE 7, SYMBIAN, BLACKBERRY, WEBOS, a variety of UNIX operating systems; or a proprietary operating system for computerized devices. The operating system may provide a platform for the execution of application programs that facilitate interaction between the computing device and a user.

The mobile computing device 810 may present a graphical user interface with the touchscreen 812. A graphical user interface is a collection of one or more graphical interface elements and may be static (e.g., the display appears to remain the same over a period of time), or may be dynamic (e.g., the graphical user interface includes graphical interface elements that animate without user input).

A graphical interface element may be text, lines, shapes, images, or combinations thereof. For example, a graphical interface element may be an icon that is displayed on the desktop and the icon's associated text. In some examples, a graphical interface element is selectable with user-input. For example, a user may select a graphical interface element by pressing a region of the touchscreen that corresponds to a display of the graphical interface element. In some examples, the user may manipulate a trackball to highlight a single graphical interface element as having focus. User-selection of a graphical interface element may invoke a pre-defined action by the mobile computing device. In some examples, selectable graphical interface elements further or alternatively correspond to a button on the keyboard 814. User-selection of the button may invoke the pre-defined action.

In some examples, the operating system provides a “desktop” graphical user interface that is displayed after turning on the mobile computing device 810, after activating the mobile computing device 810 from a sleep state, after “unlocking” the mobile computing device 810, or after receiving user-selection of the “home” button 818c. The desktop graphical user interface may display several graphical interface elements that, when selected, invoke corresponding application programs. An invoked application program may present a graphical interface that replaces the desktop graphical user interface until the application program terminates or is hidden from view.

User-input may influence an executing sequence of mobile computing device 810 operations. For example, a single-action user input (e.g., a single tap of the touchscreen, swipe across the touchscreen, contact with a button, or combination of these occurring at a same time) may invoke an operation that changes a display of the user interface. Without the user-input, the user interface may not have changed at a particular time. For example, a multi-touch user input with the touchscreen 812 may invoke a mapping application to “zoom-in” on a location, even though the mapping application may have by default zoomed-in after several seconds.

The desktop graphical interface can also display “widgets.” A widget is one or more graphical interface elements that are associated with an application program that is executing, and that display on the desktop content controlled by the executing application program. A widget's application program may launch as the mobile device turns on. Further, a widget may not take focus of the full display. Instead, a widget may only “own” a small portion of the desktop, displaying content and receiving touchscreen user-input within the portion of the desktop.

The mobile computing device 810 may include one or more location-identification mechanisms. A location-identification mechanism may include a collection of hardware and software that provides the operating system and application programs an estimate of the mobile device's geographical position. A location-identification mechanism may employ satellite-based positioning techniques, base station transmitting antenna identification, multiple base station triangulation, internet access point IP location determinations, inferential identification of a user's position based on search engine queries, and user-supplied identification of location (e.g., by receiving user a “check in” to a location).

The mobile computing device 810 may include other applications, computing sub-systems, and hardware. A call handling unit may receive an indication of an incoming telephone call and provide a user the capability to answer the incoming telephone call. A media player may allow a user to listen to music or play movies that are stored in local memory of the mobile computing device 810. The mobile computing device 810 may include a digital camera sensor, and corresponding image and video capture and editing software. An internet browser may enable the user to view content from a web page by typing in an addresses corresponding to the web page or selecting a link to the web page.

The mobile computing device 810 may include an antenna to wirelessly communicate information with the base station 840. The base station 840 may be one of many base stations in a collection of base stations (e.g., a mobile telephone cellular network) that enables the mobile computing device 810 to maintain communication with a network 850 as the mobile computing device is geographically moved. The computing device 810 may alternatively or additionally communicate with the network 850 through a Wi-Fi router or a wired connection (e.g., ETHERNET, USB, or FIREWIRE). The computing device 810 may also wirelessly communicate with other computing devices using BLUETOOTH protocols, or may employ an ad-hoc wireless network.

A service provider that operates the network of base stations may connect the mobile computing device 810 to the network 850 to enable communication between the mobile computing device 810 and other computing systems that provide services 860. Although the services 860 may be provided over different networks (e.g., the service provider's internal network, the Public Switched Telephone Network, and the Internet), network 850 is illustrated as a single network. The service provider may operate a server system 852 that routes information packets and voice data between the mobile computing device 810 and computing systems associated with the services 860.

The network 850 may connect the mobile computing device 810 to the Public Switched Telephone Network (PSTN) 862 in order to establish voice or fax communication between the mobile computing device 810 and another computing device. For example, the service provider server system 852 may receive an indication from the PSTN 862 of an incoming call for the mobile computing device 810. Conversely, the mobile computing device 810 may send a communication to the service provider server system 852 initiating a telephone call using a telephone number that is associated with a device accessible through the PSTN 862.

The network 850 may connect the mobile computing device 810 with a Voice over Internet Protocol (VoIP) service 864 that routes voice communications over an IP network, as opposed to the PSTN. For example, a user of the mobile computing device 810 may invoke a VoIP application and initiate a call using the program. The service provider server system 852 may forward voice data from the call to a VoIP service, which may route the call over the internet to a corresponding computing device, potentially using the PSTN for a final leg of the connection.

An application store 866 may provide a user of the mobile computing device 810 the ability to browse a list of remotely stored application programs that the user may download over the network 850 and install on the mobile computing device 810. The application store 866 may serve as a repository of applications developed by third-party application developers. An application program that is installed on the mobile computing device 810 may be able to communicate over the network 850 with server systems that are designated for the application program. For example, a VoIP application program may be downloaded from the Application Store 866, enabling the user to communicate with the VoIP service 864.

The mobile computing device 810 may access content on the internet 868 through network 850. For example, a user of the mobile computing device 810 may invoke a web browser application that requests data from remote computing devices that are accessible at designated universal resource locations. In various examples, some of the services 860 are accessible over the internet.

The mobile computing device may communicate with a personal computer 870. For example, the personal computer 870 may be the home computer for a user of the mobile computing device 810. Thus, the user may be able to stream media from his personal computer 870. The user may also view the file structure of his personal computer 870, and transmit selected documents between the computerized devices.

A voice recognition service 872 may receive voice communication data recorded with the mobile computing device's microphone 822, and translate the voice communication into corresponding textual data. In some examples, the translated text is provided to a search engine as a web query, and responsive search engine search results are transmitted to the mobile computing device 810.

The mobile computing device 810 may communicate with a social network 874. The social network may include numerous members, some of which have agreed to be related as acquaintances. Application programs on the mobile computing device 810 may access the social network 874 to retrieve information based on the acquaintances of the user of the mobile computing device. For example, an “address book” application program may retrieve telephone numbers for the user's acquaintances. In various examples, content may be delivered to the mobile computing device 810 based on social network distances from the user to other members in a social network graph of members and connecting relationships. For example, advertisement and news article content may be selected for the user based on a level of interaction with such content by members that are “close” to the user (e.g., members that are “friends” or “friends of friends”).

The mobile computing device 810 may access a personal set of contacts 876 through network 850. Each contact may identify an individual and include information about that individual (e.g., a phone number, an email address, and a birthday). Because the set of contacts is hosted remotely to the mobile computing device 810, the user may access and maintain the contacts 876 across several devices as a common set of contacts.

The mobile computing device 810 may access cloud-based application programs 878. Cloud-computing provides application programs (e.g., a word processor or an email program) that are hosted remotely from the mobile computing device 810, and may be accessed by the device 810 using a web browser or a dedicated program. Example cloud-based application programs include GOOGLE DOCS word processor and spreadsheet service, GOOGLE GMAIL webmail service, and PICASA picture manager.

Mapping service 880 can provide the mobile computing device 810 with street maps, route planning information, and satellite images. An example mapping service is GOOGLE MAPS. The mapping service 880 may also receive queries and return location-specific results. For example, the mobile computing device 810 may send an estimated location of the mobile computing device and a user-entered query for “pizza places” to the mapping service 880. The mapping service 880 may return a street map with “markers” superimposed on the map that identify geographical locations of nearby “pizza places.”

Turn-by-turn service 882 may provide the mobile computing device 810 with turn-by-turn directions to a user-supplied destination. For example, the turn-by-turn service 882 may stream to device 810 a street-level view of an estimated location of the device, along with data for providing audio commands and superimposing arrows that direct a user of the device 810 to the destination.

Various forms of streaming media 884 may be requested by the mobile computing device 810. For example, computing device 810 may request a stream for a pre-recorded video file, a live television program, or a live radio program. Example services that provide streaming media include YOUTUBE and PANDORA.

A micro-blogging service 886 may receive from the mobile computing device 810 a user-input post that does not identify recipients of the post. The micro-blogging service 886 may disseminate the post to other members of the micro-blogging service 886 that agreed to subscribe to the user.

A search engine 888 may receive user-entered textual or verbal queries from the mobile computing device 810, determine a set of internet-accessible documents that are responsive to the query, and provide to the device 810 information to display a list of search results for the responsive documents. In examples where a verbal query is received, the voice recognition service 872 may translate the received audio into a textual query that is sent to the search engine.

These and other services may be implemented in a server system 890. A server system may be a combination of hardware and software that provides a service or a set of services. For example, a set of physically separate and networked computerized devices may operate together as a logical server system unit to handle the operations necessary to offer a service to hundreds of computing devices. A server system is also referred to herein as a computing system.

In various implementations, operations that are performed “in response to” or “as a consequence of” another operation (e.g., a determination or an identification) are not performed if the prior operation is unsuccessful (e.g., if the determination was not performed). Operations that are performed “automatically” are operations that are performed without user intervention (e.g., intervening user input). Features in this document that are described with conditional language may describe implementations that are optional. In some examples, “transmitting” from a first device to a second device includes the first device placing data into a network for receipt by the second device, but may not include the second device receiving the data. Conversely, “receiving” from a first device may include receiving the data from a network, but may not include the first device transmitting the data.

“Determining” by a computing system can include the computing system requesting that another device perform the determination and supply the results to the computing system. Moreover, “displaying” or “presenting” by a computing system can include the computing system sending data for causing another device to display or present the referenced information.

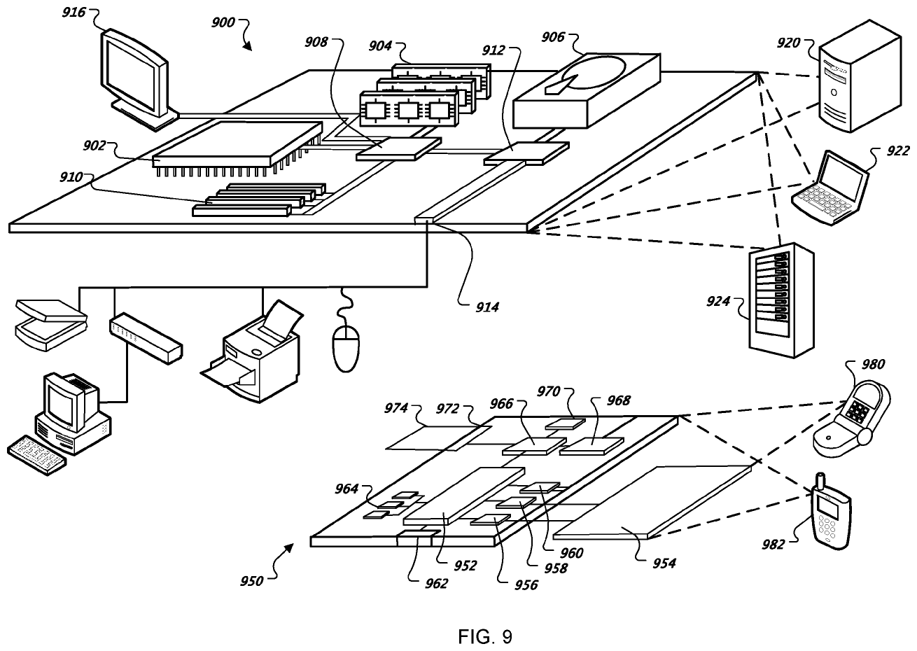

FIG. 9 is a block diagram of computing devices 900, 950 that may be used to implement the systems and methods described in this document, as either a client or as a server or plurality of servers. Computing device 900 is intended to represent various forms of digital computers, such as laptops, desktops, workstations, personal digital assistants, servers, blade servers, mainframes, and other appropriate computers. Computing device 950 is intended to represent various forms of mobile devices, such as personal digital assistants, cellular telephones, smartphones, and other similar computing devices. The components shown here, their connections and relationships, and their functions, are meant to be examples only, and are not meant to limit implementations described and/or claimed in this document.

Computing device 900 includes a processor 902, memory 904, a storage device 906, a high-speed controller 908 connecting to memory 904 and high-speed expansion ports 910, and a low speed controller 912 connecting to low speed expansion port 914 and storage device 906. Each of the components 902, 904, 906, 908, 910, and 912, are interconnected using various busses, and may be mounted on a common motherboard or in other manners as appropriate. The processor 902 can process instructions for execution within the computing device 900, including instructions stored in the memory 904 or on the storage device 906 to display graphical information for a GUI on an external input/output device, such as display 916 coupled to high-speed controller 908. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 904 stores information within the computing device 900. In one implementation, the memory 904 is a volatile memory unit or units. In another implementation, the memory 904 is a non-volatile memory unit or units. The memory 904 may also be another form of computer-readable medium, such as a magnetic or optical disk.

The storage device 906 is capable of providing mass storage for the computing device 900. In one implementation, the storage device 906 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 904, the storage device 906, or memory on processor 902.

The high-speed controller 908 manages bandwidth-intensive operations for the computing device 900, while the low speed controller 912 manages lower bandwidth-intensive operations. Such allocation of functions is an example only. In one implementation, the high-speed controller 908 is coupled to memory 904, display 916 (e.g., through a graphics processor or accelerator), and to high-speed expansion ports 910, which may accept various expansion cards (not shown). In the implementation, low-speed controller 912 is coupled to storage device 906 and low-speed expansion port 914. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 920, or multiple times in a group of such servers. It may also be implemented as part of a rack server system 924. In addition, it may be implemented in a personal computer such as a laptop computer 922. Alternatively, components from computing device 900 may be combined with other components in a mobile device (not shown), such as device 950. Each of such devices may contain one or more of computing device 900, 950, and an entire system may be made up of multiple computing devices 900, 950 communicating with each other.

Computing device 950 includes a processor 952, memory 964, an input/output device such as a display 954, a communication interface 966, and a transceiver 968, among other components. The device 950 may also be provided with a storage device, such as a microdrive or other device, to provide additional storage. Each of the components 950, 952, 964, 954, 966, and 968, are interconnected using various buses, and several of the components may be mounted on a common motherboard or in other manners as appropriate.

The processor 952 can execute instructions within the computing device 950, including instructions stored in the memory 964. The processor may be implemented as a chipset of chips that include separate and multiple analog and digital processors. Additionally, the processor may be implemented using any of a number of architectures. For example, the processor may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 950, such as control of user interfaces, applications run by device 950, and wireless communication by device 950.

Processor 952 may communicate with a user through control interface 958 and display interface 956 coupled to a display 954. The display 954 may be, for example, a TFT (Thin-Film-Transistor Liquid Crystal Display) display or an OLED (Organic Light Emitting Diode) display, or other appropriate display technology. The display interface 956 may comprise appropriate circuitry for driving the display 954 to present graphical and other information to a user. The control interface 958 may receive commands from a user and convert them for submission to the processor 952. In addition, an external interface 962 may be provide in communication with processor 952, so as to enable near area communication of device 950 with other devices. External interface 962 may provided, for example, for wired communication in some implementations, or for wireless communication in other implementations, and multiple interfaces may also be used.

The memory 964 stores information within the computing device 950. The memory 964 can be implemented as one or more of a computer-readable medium or media, a volatile memory unit or units, or a non-volatile memory unit or units. Expansion memory 974 may also be provided and connected to device 950 through expansion interface 972, which may include, for example, a SIMM (Single In Line Memory Module) card interface. Such expansion memory 974 may provide extra storage space for device 950, or may also store applications or other information for device 950. Specifically, expansion memory 974 may include instructions to carry out or supplement the processes described above, and may include secure information also. Thus, for example, expansion memory 974 may be provide as a security module for device 950, and may be programmed with instructions that permit secure use of device 950. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 964, expansion memory 974, or memory on processor 952 that may be received, for example, over transceiver 968 or external interface 962.

Device 950 may communicate wirelessly through communication interface 966, which may include digital signal processing circuitry where necessary. Communication interface 966 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 968. In addition, short-range communication may occur, such as using a Bluetooth, WiFi, or other such transceiver (not shown). In addition, GPS (Global Positioning System) receiver module 970 may provide additional navigation- and location-related wireless data to device 950, which may be used as appropriate by applications running on device 950.

Device 950 may also communicate audibly using audio codec 960, which may receive spoken information from a user and convert it to usable digital information. Audio codec 960 may likewise generate audible sound for a user, such as through a speaker, e.g., in a handset of device 950. Such sound may include sound from voice telephone calls, may include recorded sound (e.g., voice messages, music files, etc.) and may also include sound generated by applications operating on device 950.

The computing device 950 may be implemented in a number of different forms, as shown in the figure. For example, it may be implemented as a cellular telephone 980. It may also be implemented as part of a smartphone 982, personal digital assistant, or other similar mobile device.

Additionally computing device 900 or 950 can include Universal Serial Bus (USB) flash drives. The USB flash drives may store operating systems and other applications. The USB flash drives can include input/output components, such as a wireless transmitter or USB connector that may be inserted into a USB port of another computing device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. Moreover, other mechanisms for performing the systems and methods described in this document may be used. In addition, the logic flows depicted in the figures do not require the particular order shown, or sequential order, to achieve desirable results. Other steps may be provided, or steps may be eliminated, from the described flows, and other components may be added to, or removed from, the described systems. Accordingly, other implementations are within the scope of the following claims.

1. A computer-implemented method for detecting a mobile device pointing gesture toward another device, comprising:
determining that a mobile computing device physically moved in a manner that satisfies criterion for a pointing gesture;
determining that the pointing gesture is oriented toward a particular device, including by:
(i) receiving, by a receiving device of the mobile computing device and the particular device, a signal that was transmitted by a transmitting device of the mobile computing device and the particular device, using a first antenna of the receiving device and a second antenna of the receiving device;
(ii) determining an indication of a signal difference between receipt of the signal by the first antenna and the second antenna;
(iii) identifying a physical orientation of the mobile computing device;
(iv) determining an indication of a compensated signal difference by adjusting the indication of the signal difference based on the physical orientation of the mobile computing device; and
(v) determining that the indication of the compensated signal difference satisfies criterion for the pointing gesture being oriented toward the particular device; and
initiating a particular activity between the mobile computing device and the particular device, based on having determined both that (a) the mobile computing device physically moved in the manner that satisfies the criterion for the pointing gesture, and (b) the pointing gesture is oriented toward the particular device.

2. The computer-implemented method of claim 1, wherein the indication of signal difference between receipt of the signal by the first antenna and the second antenna comprises:
an indication of a phase difference between receipt of the signal by the first antenna and the second antenna;
an indication of a timing difference between receipt of the signal by the first antenna and the second antenna; or
an indication of a gain difference between receipt of the signal by the first antenna and the second antenna.

3. The computer-implemented method of claim 1, wherein identifying the physical orientation of the mobile computing device includes identifying an amount that the mobile computing device is tilted away from a vertical orientation.

4. The computer-implemented method of claim 3, wherein determining the indication of the compensated signal difference includes accessing first compensation data that correlates the amount that the mobile computing device is tilted away from the vertical orientation to an amount of error in the indication of the signal difference.

5. The computer-implemented method of claim 4, wherein:
the mobile computing device comprises the receiving device and the particular device comprises the transmitting device;
the first compensation data indicates how to compensate the signal difference for signal transmissions between a combination of a first type of device that includes the mobile computing device and a second type of device that includes the particular device;
the method comprises:
(i) receiving, by the mobile computing device, a second signal that was transmitted by a second transmitting device, using the first antenna and the second antenna of the mobile computing device;
(ii) determining a second indication of a signal difference between receipt of the second signal by the first antenna and the second antenna; and
(iii) determining a second indication of a compensated phase difference by adjusting the second indication of the signal difference based on the physical orientation of the mobile computing device, including by applying second compensation data that indicates how to compensate phase for signal transmissions between a combination of the first type of device that includes the mobile computing device and a third type of device that includes the second transmitting device, the third type of device being different from the second type of device and the second compensation data being different from the first compensation data; and
the indication of the compensated signal difference represents a lesser signal difference than the second indication of the compensated signal difference, such that the pointing gesture is determined to be oriented toward the particular device and not the second transmitting device.

6. The computer-implemented method of claim 1, wherein determining that the mobile computing device physically moved in the manner that satisfies the criterion for the pointing gesture includes:
(a) determining that the mobile computing device physically tilted away from a vertical orientation by a threshold amount of tilt; and
(b) determining that the mobile computing device physically moved laterally a threshold amount of lateral movement.

7. The computer-implemented method of claim 6, wherein the mobile computing device physically tilted away from the vertical orientation the threshold amount of tilt at least partially while the mobile computing device physically moved laterally the threshold amount of lateral movement.

8. The computer-implemented method of claim 6, wherein determining that the mobile computing device physically tilted away from the vertical orientation and physically moved laterally the threshold amount of lateral movement is based on measurements from one or more orientation or movement sensors of the mobile computing device.

9. The computer-implemented method of claim 6, wherein determining that the mobile computing device physically moved in the manner that satisfies the criterion for the pointing gesture includes:
(c) determining that the mobile computing device satisfied criterion for remaining stationary and tilted, after the mobile computing device physically tilted away from the vertical orientation and physically moved laterally,
wherein the receiving device receives the signal at least partially while the mobile computing device satisfied the criterion for remaining stationary and tilted.

10. The computer-implemented method of claim 1, wherein:
the mobile computing device comprises the receiving device and the particular device comprises the transmitting device, such that the mobile computing device receives the signal and the signal was transmitted by the particular device.

11. The computer-implemented method of claim 10, wherein:
the mobile computing device includes a top end, a bottom end opposite the top end, a front face that presents a display device and that is located between the top end and the bottom end, and a back face opposite the front face; and
the first antenna and the second antenna are positioned to receive signals at the back face of the mobile computing device, are located between the top end and the bottom end at a same vertical height within the mobile computing device, and are laterally separated from each other at the vertical height.

12. The computer-implemented method of claim 11, wherein:
determining that the mobile computing device physically moved in the manner that satisfies the criterion for the pointing gesture includes determining that the mobile computing device tilted away from a vertical orientation, such that the back face titled downward and the bottom end tilted upward.

13. The computer-implemented method of claim 1, wherein the particular activity includes casting media that is playing or is queued for play by the mobile computing device for playback by the particular device.

14. The computer-implemented method of claim 13, wherein initiating the particular activity includes presenting, by a touchscreen display device of the mobile computing device, a user-selectable prompt to begin casting the media.

15. The computer-implemented method of claim 1, wherein the signal received by the receiving device and transmitted by the transmitting device comprises an ultra-wideband signal.

16. One or more computer-readable devices including instructions thereon that, when executed by one or more processors, cause performance of operations that include:
determining that a mobile computing device physically moved in a manner that satisfies criterion for a pointing gesture;
determining that the pointing gesture is oriented toward a particular device, including by:
(i) receiving, by a receiving device of the mobile computing device and the particular device, a signal that was transmitted by a transmitting device of the mobile computing device and the particular device, using a first antenna of the receiving device and a second antenna of the receiving device;
(ii) determining an indication of a signal difference between receipt of the signal by the first antenna and the second antenna;
(iii) identifying a physical orientation of the mobile computing device;
(iv) determining an indication of a compensated signal difference by adjusting the indication of the signal difference based on the physical orientation of the mobile computing device; and
(v) determining that the indication of the compensated signal difference satisfies criterion for the pointing gesture being oriented toward the particular device; and
initiating a particular activity between the mobile computing device and the particular device, based on having determined both that (a) the mobile computing device physically moved in the manner that satisfies the criterion for the pointing gesture, and (b) the pointing gesture is oriented toward the particular device.

17. A mobile computing device comprising:
a first antenna;
a second antenna;
one or more processors;
one or more computer-readable devices including instructions that, when executed by the one or more processors, cause performance of operations that include:
determining that the mobile computing device physically moved in a manner that satisfies criterion for a pointing gesture;
determining that the pointing gesture is oriented toward a particular device, including by:
(i) receiving, by the mobile computing device, a signal that was transmitted by the particular device, using the first antenna and the second antenna of the mobile computing device;
(ii) determining an indication of a signal difference between receipt of the signal by the first antenna and the second antenna;
(iii) identifying a physical orientation of the mobile computing device;
(iv) determining an indication of a compensated signal difference by adjusting the indication of the signal difference based on the physical orientation of the mobile computing device; and
(v) determining that the indication of the compensated signal difference satisfies criterion for the pointing gesture being oriented toward the particular device; and
initiating a particular activity between the mobile computing device and the particular device, based on having determined both that (a) the mobile computing device physically moved in the manner that satisfies the criterion for the pointing gesture, and (b) the pointing gesture is oriented toward the particular device.
